(19) United States
(12) Patent Application Publication
(10) Pub. No.: US 2004/0085284 A1
(43) Pub. Date: May 6, 2004

(54) Scan driving circuit for use in planar display

(75) Inventors: Jun-Chang Chen, Taichung (TW); Chaung-Ming Chiu, Taoyuan (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Toppoly Optoelectronics Corp., Miao-Li County (TW)

(21) Appl. No.: 10/694,117

(22) Filed: Oct. 27, 2003

(30) Foreign Application Priority Data
Oct. 31, 2002 (TW) 091132320

(51) Int. Cl. G09G 3/36

(52) U.S. Cl. 345/100

(57) ABSTRACT

A scan driving circuit includes a first sub-circuit and a second sub-circuit. The first sub-circuit receives a driving signal and outputs the driving signal to a first scan line of the active matrix via a first output terminal after a predetermined time delay. The second sub-circuit is electrically connected to the first sub-circuit, receives the driving signal transferred from a second output terminal of the first sub-circuit, and outputs the driving signal to a second scan line of an active matrix after the predetermined time delay. Furthermore, the first sub-circuit includes a unidirectional conducting device electrically connected between the first output terminal and the second output terminal.

### FIELD OF THE INVENTION

The present invention relates to a scan driving circuit, and more particularly to a scan driving circuit for use in a planar display.

### BACKGROUND OF THE INVENTION

With the increasing development of manufacturing technology, the semiconductor materials used for fabricating TFTLCDs (Thin film transistor-Liquid crystal displays) are generally low-temperature polysilicon (LTPS) in place of traditional amorphous silicon. The LTPS-TFT has higher electronic mobility than the TFT made of amorphous silicon. A typical liquid crystal display principally comprises a scan driving circuit and an active matrix. Conventionally, the active matrix is disposed on the display panel, and the scan driving circuit for driving the active matrix is arranged outside the display panel. Whereas, the scan driving circuit and the active matrix are integrated into the display panel in current liquid crystal displays. The common processes for fabricating integrated circuits comprise NMOS, CMOS and PMOS processes. Since the PMOS process involves in least masking numbers and least manufacturing steps among these processes, the PMOS process is widely employed to fabricate scan driving circuits and active matrices of display panels, especially large-size display panels.

Since the sizes of panel displays are growing larger and larger, single scan driving circuit could not catch up with the requirement on driving capability. Therefore, a bilateral scan driving circuit is developed for a purpose of enhancing driving capability. FIG. 1 is a schematic circuit block diagram illustrating the configuration of a conventional bilateral scan driving circuit for use in a LCD panel. The bilateral scan driving circuit comprises two vertical scan driving circuits 11 disposed on both sides of the active matrix 10. Each of the vertical scan driving circuits 11 comprises a plurality of sub-circuits, e.g. DC1, DC2 and DC3 as shown. Each sub-circuit comprises a shift register, e.g. A1, A2 and A3 as shown, a buffer circuit, e.g. B1, B2 and B3 as shown, and an electro-static discharge (ESD) protection circuit, e.g. C1, C2 and C3 as shown. In spite three sub-circuits are illustrated to be included in each vertical scan driving circuit are shown in the drawing, more than three sub-circuits can also be included in a similar manner. In response to a clock signal, each shift register generates a driving signal. For a purpose of increasing driving power, the driving signal is then amplified by the buffer circuit downstream of the shift register so as to turn on the thin film transistors of the same row. The scan lines are successively driven by the vertical scan driving circuits 11 so as to sequentially turn on the thin film transistors row by row. Each ESD protection circuit is used for preventing from ESD damage.

It is apparent from FIG. 1 that each shift register is controlled by the amplified driving signal from a buffer circuit of the preceding sub-circuit. For example, the shift register A2 is controlled by the amplified driving signal outputted from the buffer circuit B1. Likewise, the shift register A3 is controlled by the amplified driving signal outputted from the buffer circuit B2. Since two adjacent scan lines of the active matrix 10 is possibly shorted, as indicated by the dash line a-b, due to some inherent adverse factors rendered by the manufacturing process, the buffer circuit B2 needs to drive double thin film transistors in the active matrix 10. Therefore, the amplified driving signal from preceding buffer circuit B2 might have insufficient power to drive the shift register A3. Likewise, the buffer circuit B3 also has to drive double thin film transistors in the active matrix 10. In such circumstance, the successive scan lines could not be effectively driven to maintain normal operation of the display.

### SUMMARY OF THE INVENTION

It is an object of the present invention to provide a driving circuit for driving an active matrix of a display panel to exempt from the adverse effect of the load of the upstream sub-circuit on the driving capability of the downstream sub-circuit.

In accordance with a first aspect of the present invention, there is provided with a scan driving circuit for use in a planar display comprising an active matrix. The scan driving circuit comprises a first sub-circuit and a second sub-circuit. The first sub-circuit receives a driving signal and outputs the driving signal to a first scan line of the active matrix via a first output terminal after a predetermined time delay. The second sub-circuit is electrically connected to the first sub-circuit, receives the driving signal transferred from a second output terminal of the first sub-circuit, and outputs the driving signal to a second scan line of the active matrix after the predetermined time delay. Furthermore, the first sub-circuit comprises a unidirectional conducting device electrically connected between the first output terminal and the second output terminal.

In an embodiment, the first sub-circuit comprises a shift register and a buffer circuit. The shift register receives the driving signal and outputs the driving signal after the predetermined time delay in response to a clock signal. The buffer circuit is electrically connected to the shift register, the active matrix and the second sub-circuit, amplifies power of the driving signal, and outputs the amplified driving signal to the active matrix and the second sub-circuit via the first output terminal and the second output terminal, respectively.

In an embodiment, the first sub-circuit further comprises an electrostatic discharge protection circuit electrically connected to the first output terminal of the buffer circuit for protecting the scan driving circuit from electrostatic discharge damage.

In an embodiment, the buffer circuit of the first sub-circuit comprises a plurality of NOT gates arranged in series.

In an embodiment, the buffer circuit of the first sub-circuit comprises at least an NOT gate electrically connected between the first output terminal and the second output terminal in series functioning as the unidirectional conducting device.

In an embodiment, the NOT gates is one selected from a group consisting of an NMOS NOT gate, a PMOS NOT gate and a CMOS NOT gate.

In an embodiment, the second sub-circuit comprises a shift register and a buffer circuit. The shift register is electrically connected to the second output terminal of the first sub-circuit, receives the driving signal transferred from the second output terminal of the first sub-circuit, and outputs the driving signal after the predetermined time delay in response to the clock signal. The buffer circuit is electrically connected to the shift register, the active matrix and the second sub-circuit, amplifies power of the driving signal, and outputs the amplified driving signal to the second scan lone of the active matrix via the first output terminal.

In an embodiment, the second sub-circuit further comprises an electro-static discharge protection circuit electrically connected to the first output terminal of the buffer circuit for protecting the scan driving circuit from electro-static discharge damage.

In an embodiment, the buffer circuit of the second sub-circuit comprises a plurality of NOT gates arranged in series. Preferably, the NOT gates is one selected from a group consisting of an NMOS NOT gate, a PMOS NOT gate and a CMOS NOT gate.

In accordance with a first aspect of the present invention, there is provided with a scan driving circuit for driving an active matrix of a planar display. The scan driving circuit comprises a plurality of sub-circuits each in communication with one of scan lines of the active matrix. One of the sub-circuits comprises a signal receiving device, a signal amplifying device, a unidirectional conducting device and a second output terminal. The signal receiving device is used for receiving a driving signal from preceding sub-circuit. The signal amplifying device is used for amplifying power of the driving signal and outputting an amplified driving signal. The unidirectional conducting device is disposed downstream of the signal amplifying device for transferring the amplified driving signal to the one of the scan lines unidirectionally via a first output terminal. The second output terminal is electrically connected to the signal amplifying device and next sub-circuit for transferring the amplified driving signal to the next sub-circuit.

In an embodiment, the signal receiving device is a shift register.

In an embodiment, the driving signal received by the signal receiving device is transferred to the signal amplifying device after a predetermined time delay in response to a clock signal.

In an embodiment, the signal amplifying device and the unidirectional conducting device are included in a buffer circuit.

In an embodiment, the signal amplifying device comprises a plurality of NOT gates arranged in series, and the unidirectional conducting device comprises at least an NOT gate electrically connected between the first and the second output terminals in series.

In an embodiment, the scan driving circuit further comprises an electro-static discharge protection circuit electrically connected to the one sub-circuit and the one of the scan lines for protecting the scan driving circuit from electro-static discharge damage.

In accordance with a first aspect of the present invention, there is provided with a scan driving circuit for driving an active matrix of a planar display. The scan driving circuit comprises a plurality of sub-circuits each in communication with one of scan lines of the active matrix. One of the sub-circuits comprises a signal receiving device and a buffer circuit. The signal receiving device is used for receiving a driving signal from preceding sub-circuit. The buffer circuit comprises a signal amplifying device for amplifying power of the driving signal to output an amplified driving signal, an output terminal for transferring the amplified driving signal to next sub-circuit, and a unidirectional conducting device for transferring the amplified driving signal to the one of the scan lines unidirectionally.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram illustrating the configuration of a conventional bilateral scan driving circuit for use in a LCD panel;

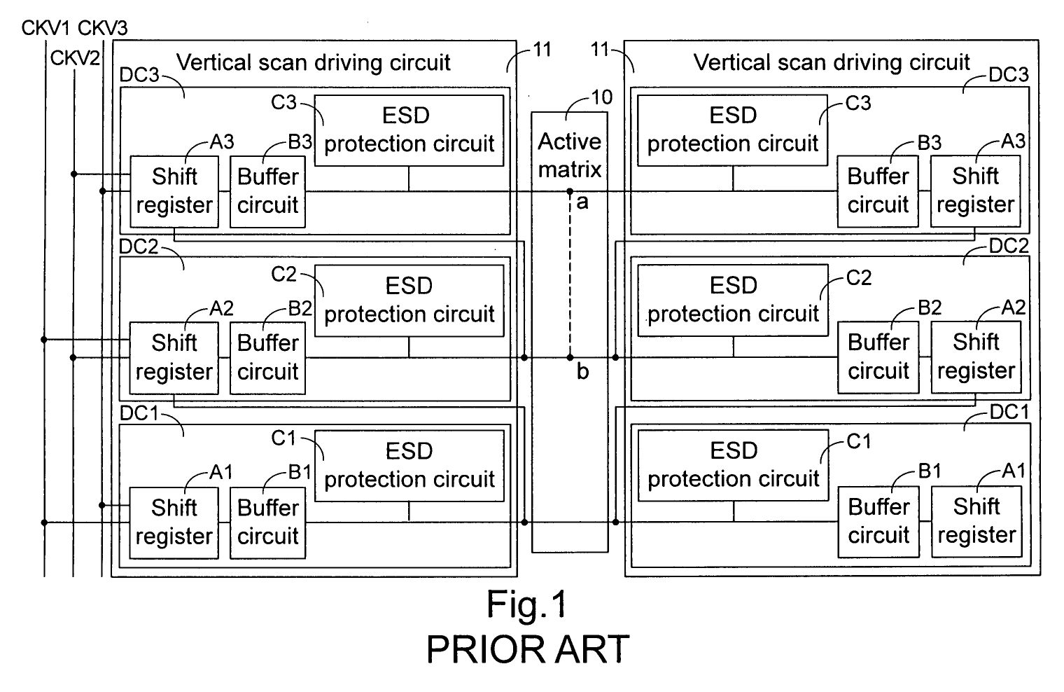

FIG. 2 is a schematic circuit block diagram illustrating the configuration of a scan driving circuit for use in a LCD panel according to a preferred embodiment of the present invention;

FIG. 3 is a schematic circuit block diagram illustrating the configuration of a buffer circuit; and

FIG. 4 is a schematic circuit block diagram illustrating the configuration of a PMOS NOT gate.

### DETAILED DESCRIPTION OF THE PREFERRED EMBODIMENT

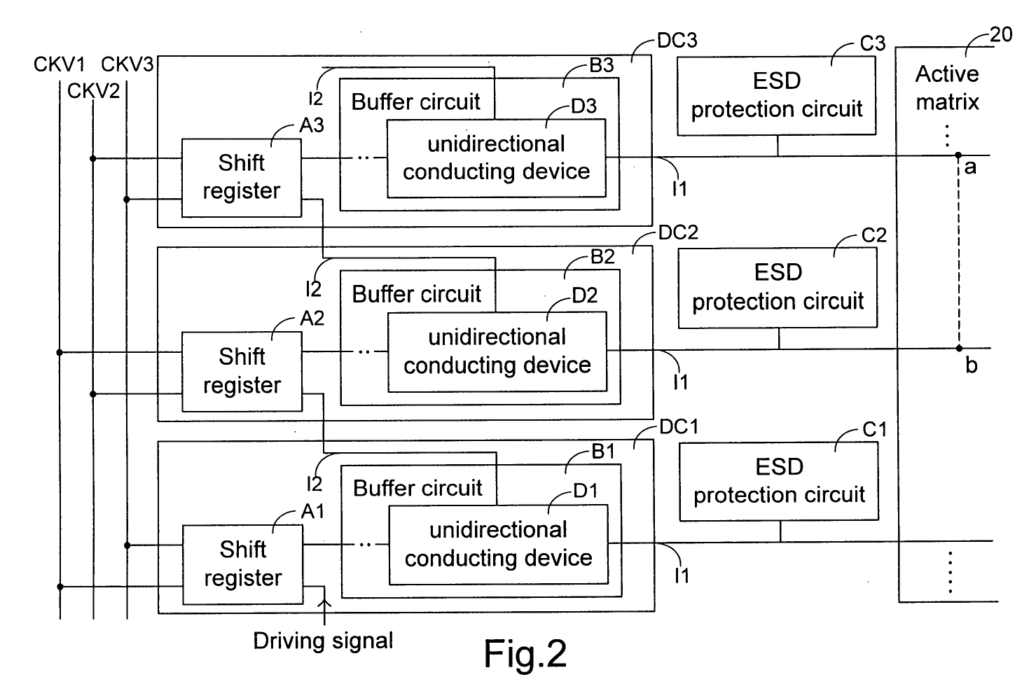

Please refer to FIG. 2, which illustrates a scan driving circuit for use in a LCD panel according to a preferred embodiment of the present invention. The scan driving circuit is a bilateral scan driving circuit. For neat drawings, however, only the vertical scan driving circuit at one side of the active matrix 20 is shown. The vertical scan driving circuits comprises a plurality of sub-circuits, e.g. DC1, DC2 and DC3 as shown. Each sub-circuit comprises a shift register, e.g. A1, A2 or A3, and a buffer circuit, e.g. B1, B2 or B3, as shown. In spite three sub-circuits are illustrated to be included in each vertical scan driving circuit are shown in the drawing, more than three sub-circuits can also be included in a similar manner. In response to clock signals CKV1˜CKV3, each shift register receives and then latches the driving signal from the preceding sub-circuit, and after a predetermined time delay, the driving signal is amplified by the buffer circuit downstream of the shift register. The amplified driving signal is transferred to a corresponding scan line and the next sub-circuit via a first output terminal I1 and a second output terminal 12, respectively. Each sub-circuit of the vertical scan driving circuit further comprises an electro-static discharge (ESD) protection circuit, e.g. C1, C2 or C3 as shown, which is electrically connected to the first output terminal I1 of that sub-circuit for protecting the scan driving circuit from electro-static discharge damage. The amplified driving signal transmitted from the second output terminal I2 then controls the states of the thin film transistors in next scan line. The scan lines are successively driven by the sub-circuits so as to sequentially turn on the thin film transistors in the active matrix 20 row by row.

For a purpose of avoiding the adverse effect of the load of the upstream sub-circuit on the driving capability of the downstream sub-circuit, for example due to a short circuit, the buffer circuit of each sub-circuit comprises a unidirectional conducting device, e.g. D1, D2 or D3 as shown, which is disposed downstream of the shift register. By means of these unidirectional conducting devices, the amplified driving signal is transferred to one of the scan lines unidirectionally via the first output terminal I1. If two adjacent scan lines of the active matrix 20 are shorted, as indicated by the dash line a-b, the buffer circuit B2 needs to drive double thin film transistors in the active matrix 20. However, the amplified driving signal from preceding buffer circuit B2 can still effectively drive the shift register A3.

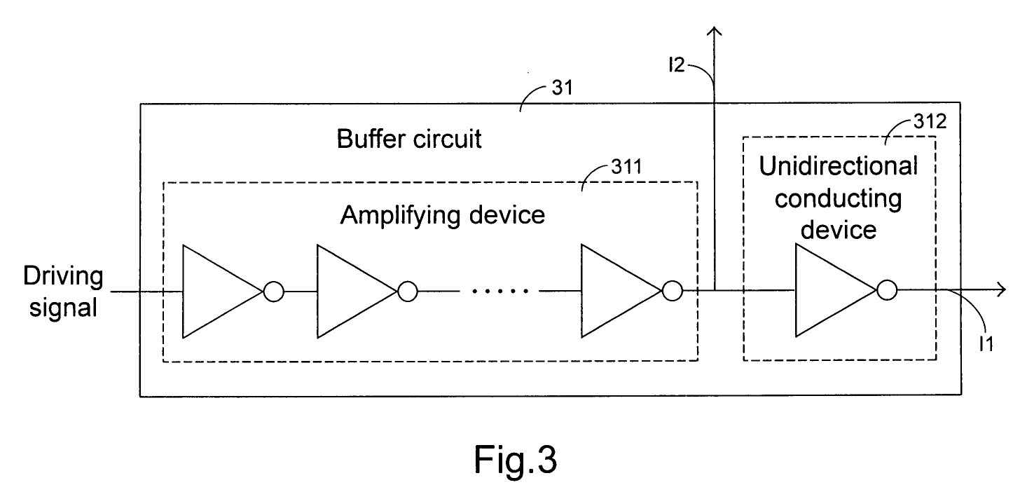

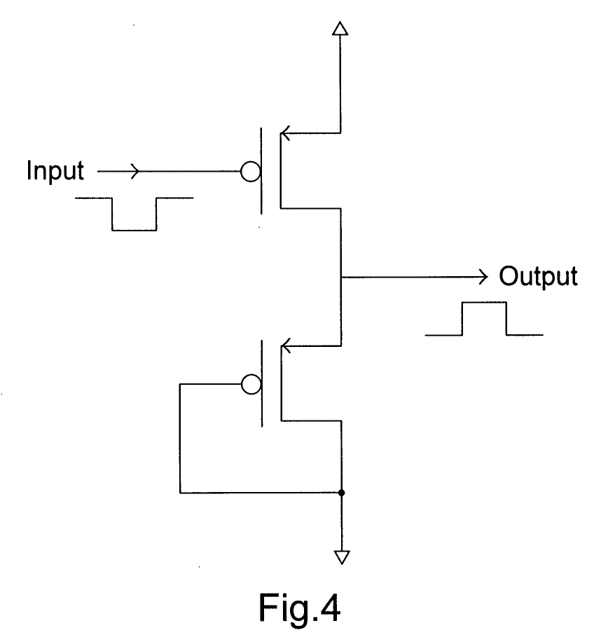

Referring to FIG. 3, each buffer circuit comprises a plurality of NOT gates arranged in series. While the upstream ones of the plurality of NOT gates function as an amplifying device for amplifying the driving signal from the shift register, one or more downstream NOT gates, as exemplified in FIG. 4 as a PMOS NOT gate, function as the unidirectional conducting device. The amplified driving signal is provided to drive current scan line via a first output terminal I1 and also transferred to next sub-circuit via a second output terminal I2, respectively. Since NOT gates are used in the unidirectional conducting device, the property of the NOT gate inherently exempts from the dependence of the input driving ability from the output loading. With such configuration, even when two adjacent scan lines are shorted and thus the driving load of the first output terminal I1 is increased, the driving power transmitted from the second output terminal I2 can still maintain normal.

In addition to PMOS NOT gates shown in FIG. 4, the NOT gates used in the buffers can also be NMOS NOT gates or CMOS NOT gates. Since the PMOS process involves in least masking numbers and least manufacturing steps among these processes, the PMOS process is widely employed to fabricate driving circuits and active matrices of display panels, especially large-size display panels.

From the above description, it is understood that the problems resulted from a short circuit can be effectively reduced by means of the arrangement of the unidirectional conducting device in the circuit of the present invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A scan driving circuit for use in a planar display comprising an active matrix, said scan driving circuit comprising:
a first sub-circuit receiving a driving signal and outputting said driving signal to a first scan line of said active matrix via a first output terminal after a predetermined time delay; and
a second sub-circuit electrically connected to said first sub-circuit, receiving said driving signal transferred from a second output terminal of said first sub-circuit, and outputting said driving signal to a second scan line of said active matrix after said predetermined time delay,
wherein said first sub-circuit further comprises a unidirectional conducting device electrically connected between said first output terminal and said second output terminal.

2. The scan driving circuit according to claim 1 wherein said first sub-circuit comprises:
a shift register receiving said driving signal and outputting said driving signal after said predetermined time delay in response to a clock signal; and
a buffer circuit electrically connected to said shift register, said active matrix and said second sub-circuit, amplifing power of said driving signal, and outputting said amplified driving signal to said active matrix and said second sub-circuit via said first output terminal and said second output terminal, respectively.

3. The scan driving circuit according to claim 2 wherein said first sub-circuit further comprises an electro-static discharge protection circuit electrically connected to said first output terminal of said buffer circuit for protecting said scan driving circuit from electro-static discharge damage.

4. The scan driving circuit according to claim 2 wherein said buffer circuit comprises a plurality of NOT gates arranged in series.

5. The scan driving circuit according to claim 4 wherein said buffer circuit comprises at least an NOT gate electrically connected between said first output terminal and said second output terminal in series functioning as said unidirectional conducting device.

6. The scan driving circuit according to claim 5 wherein said NOT gates is one selected from a group consisting of an NMOS NOT gate, a PMOS NOT gate and a CMOS NOT gate.

7. The scan driving circuit according to claim 2 wherein said second sub-circuit comprises:
a shift register electrically connected to said second output terminal of said first sub-circuit, receiving said driving signal transferred from said second output terminal of said first sub-circuit, and outputting said driving signal after said predetermined time delay in response to said clock signal; and
a buffer circuit electrically connected to said shift register, said active matrix and said second sub-circuit, amplifying power of said driving signal, and outputting said amplified driving signal to said second scan lone of said active matrix via said first output terminal.

8. The scan driving circuit according to claim 7 wherein said second sub-circuit further comprises an electro-static discharge protection circuit electrically connected to said first output terminal of said buffer circuit for protecting said scan driving circuit from electro-static discharge damage.

9. The scan driving circuit according to claim 7 wherein said buffer circuit comprises a plurality of NOT gates arranged in series.

10. The scan driving circuit according to claim 9 wherein said NOT gates is one selected from a group consisting of an NMOS NOT gate, a PMOS NOT gate and a CMOS NOT gate.

11. A scan driving circuit for driving an active matrix of a planar display, said scan driving circuit comprising a plurality of sub-circuits each in communication with one of scan lines of said active matrix, one of said sub-circuits comprising:
a signal receiving device for receiving a driving signal from preceding sub-circuit; a signal amplifing device for amplifying power of said driving signal and outputting an amplified driving signal;
a unidirectional conducting device disposed downstream of said signal amplifying device for transferring said amplified driving signal to said one of said scan lines unidirectionally via a first output terminal; and
a second output terminal electrically connected to said signal amplifying device and next sub-circuit for transferring said amplified driving signal to said next sub-circuit.

12. The scan driving circuit according to claim 11 wherein said signal receiving device is a shift register.

13. The scan driving circuit according to claim 11 wherein said driving signal received by said signal receiving device is transferred to said signal amplifying device after a predetermined time delay in response to a clock signal.

14. The scan driving circuit according to claim 11 wherein said signal amplifying device and said unidirectional conducting device are included in a buffer circuit.

15. The scan driving circuit according to claim 11 wherein said signal amplifying device comprises a plurality of NOT gates arranged in series, and said unidirectional conducting device comprises at least an NOT gate electrically connected between said first and said second output terminals in series.

16. The scan driving circuit according to claim 15 wherein said NOT gates are selected from NMOS NOT gates, PMOS NOT gates and CMOS NOT gates.

17. The scan driving circuit according to claim 11 further comprising an electro-static discharge protection circuit electrically connected to said one sub-circuit and said one of said scan lines for protecting said scan driving circuit from electro-static discharge damage.

18. A scan driving circuit for driving an active matrix of a planar display, said scan driving circuit comprising a plurality of sub-circuits each in communication with one of scan lines of said active matrix, one of said sub-circuits comprising:
a signal receiving device for receiving a driving signal from preceding sub-circuit; and
a buffer circuit comprising a signal amplifying device for amplifying power of said driving signal to output an amplified driving signal, an output terminal for transferring said amplified driving signal to next sub-circuit, and a unidirectional conducting device for transferring said amplified driving signal to said one of said scan lines unidirectionally.

19. The scan driving circuit according to claim 18 wherein said signal receiving device is a shift register.

20. The scan driving circuit according to claim 18 wherein said driving signal received by said signal receiving device is transferred to said signal amplifying device after a predetermined time delay in response to a clock signal.
